(19) United States
(12) Patent Application Publication
(10) Pub. No.: US 2005/0241396 A1
(43) Pub. Date: Nov. 3, 2005

(54) Simple method for electronically damping resonant transducers

(76) Inventors: James Emerson Huebler, Brookfield, IL (US); Albert Teitsma, Rolling Meadows, IL (US)

Correspondence Address: MARK E. FEJER;GAS TECHNOLOGY INSTITUTE, 1700 SOUTH MOUNT PROSPECT ROAD, DES PLAINES, IL, 60018, US

(21) Appl. No.: 10/838,030

(22) Filed: May 3, 2004

(51) Int. Cl. G01N 29/02

(52) U.S. Cl. 73/597; 248/550

(57) ABSTRACT

A method for electronically damping an oscillator of a resonant transducer in which a first electrical pulse is applied to the resonant transducer, oscillating the oscillator, thereby forming a first waveform having a first amplitude and a phase. A second electrical pulse is then applied to the resonant transducer, forming a second waveform having a phase delay relative to the phase of the first waveform, resulting in substantial damping of the oscillator.

### BACKGROUND OF THE INVENTION

1. Field of the Invention

This invention relates to resonant transducers and a method for damping resonant transducers. This invention also relates to a method for determining object thicknesses in environments where the couplant between the transducer and the object is a gaseous fluid. One object of particular interest is a wall, such as the wall of an underground pipeline.

2. Description of Related Art

Many transducers, such as piezoelectric transducers, are activated by a short electrical pulse or a short burst of sine waves as an input signal. The transducers, which comprise at least one oscillating element, in turn, create an output signal, such as an acoustic wave, which propagates away from the transducer. When the acoustic wave interacts with an object in its path, a reflected acoustic wave is reflected back towards the transducer and, unless the initial acoustic wave has completely dissipated, detection and measurement of the reflected acoustic wave, which is typically much smaller than the initial acoustic wave, is difficult due to interference from the initial acoustic wave. This is particularly problematic when the transducer is used in a pulse echo mode, that is, where the transducer both creates and detects the signals, because, without sufficient damping of the oscillating element, the resonant transducer is still generating a relatively large waveform when the much smaller reflected acoustic wave comes back to the resonant transducer.

Magnetic flux leakage is one method currently used to inspect natural gas transmission pipe and wall thickness is an important measure of the condition of the pipe. Thus, it is apparent that inspection of the pipe may be substantially improved by an accurate measurement of the wall thickness. To obtain wall thicknesses, ultrasonic thickness gauging is traditionally used. As is well known to those skilled in the art, ultrasonic thickness gauging requires a couplant, such as water or oil, between the transducer and the wall. However, the use of such couplants is impractical when measuring wall thickness from inside an operating natural gas pipeline. But, the technique would be practical if the gas in the pipeline could be utilized as the couplant.

Unfortunately, because of the substantial acoustic impedance mismatch between steel and compressed natural gas or other gases, most of the acoustic signal or wave launched by a resonant transducer, such as a piezoelectric transducer, reflects from the first (interior) surface of the pipe. However, a small portion of the acoustic signal enters the pipe wall and reflects from the second (back) wall. Typically, multiple reflections occur between the front and back walls. The time difference between successive returning (reflected) signals is proportional to the pipewall thickness. On each reflection from a wall, a small portion of the acoustic signal exits the pipewall. A transducer on either side of the wall can detect these signals. However, because most transmission pipe is buried underground, it is preferred that the transducer(s) be disposed inside the pipe. However, the amplitude of this reflected signal is typically a factor of 100 times or more smaller than the initial acoustic signal. As a result, the transducer is usually still vibrating from having received the first signal reflected from the interior surface of the pipe when the signal reflected from the back wall arrives. Thus, detection and discrimination of the returning pulse(s) from the second (back) wall is difficult to impossible.

Similar problems exist when trying to locate subterranean objects using ground penetrating waveforms. In this case, the problem of being able to detect the reflected signal is further exacerbated by the excitation of the transducer by waveforms reflected from the ground.

Several approaches for addressing these issues have been developed. However, each of these approaches has one or more drawbacks. U.S. Pat. No. 4,520,670 to Salomonsson et al. teaches a method and apparatus for generating short ultrasonic echo pulses by means of an ultrasonic transducer, which uses a shift register for storing a signal for excitation of the ultrasonic transducer. The stored signal is a weighted least squares filter signal to the transducer proper and is supplied to the transducer by means of a digital-to-analog converter. Repeated adjustment of the stored signal can be effected by supplying, by means of an analog-to-digital converter, the echo pulse signals from the ultrasonic transducer to a logic unit for analysis. One disadvantage of this method is that it requires output signals that can swing both positive and negative.

U.S. Pat. No. 4,222,274 to Johnson teaches the use of a ring of transmitters and receivers and signal processing to improve the resolution of biological images. It uses rotating hardware to move the sensors and it uses the Tanaka-Iinuma kernel and the Ramachandran and Lakshiminaraynan kernel as waveforms to drive the ultrasonic transmitters. Signals received by the receiver arrays are processed by a waveshaping circuit to synthetically focus the image. The desired waveform used to drive the transmitters may be developed through an analog or digital waveshaping circuit. However, this method too requires output signals that can swing both positive and negative.

Another approach to addressing these issues is to design a large amount of damping (orders of magnitude) into the transducer. However, it can be difficult to add sufficient damping, in addition to which damping compromises other desired features of the transducer, such as sensitivity Yet another approach to addressing these issues is to provide electric damping by using a feedback system that monitors the signal generated by the transducer and uses a digital filtering system to adjust the drive signal until the output waveform has the desired shape. Such an approach is taught, for example, by U.S. Pat. No. 6,167,758 B1 to Fomitchev which describes a method and apparatus for generating ultrasonic pulses of a specified waveform shape by using a shaping filter. One application of the disclosed method and apparatus is indicated to be electric damping. However, this approach requires extra circuit components, a CPU of some sort to process the signals and a high voltage amplifier that provides positive and negative voltages to the transducer.

### SUMMARY OF THE INVENTION

It is, thus, one object of this invention to provide a method for electronically damping a resonant transducer.

It is another object of this invention to provide a method and apparatus for electronically damping a resonant transducer that provides short pulses that utilize only a single polarity (positive or negative) drive circuit.

It is yet a further object of this invention to provide a method and apparatus for electronically damping a resonant transducer which does not require a feedback system to operate.

It is yet another object of this invention to provide a method for determining the thickness of objects disposed in a gaseous environment.

It is yet another object of this invention to provide a method and apparatus for locating objects buried in the ground.

These and other objects of this invention are addressed by a method for electronically damping an oscillator of a resonant transducer in which a first electrical pulse is applied to the resonant transducer, thereby oscillating the oscillator and forming a first waveform having a first amplitude and a phase. A second electrical pulse is then applied to the resonant transducer, thereby forming a second waveform having a phase delay relative to the phase of the first waveform such that substantial damping of the oscillator occurs. As used herein, the term “substantial damping” refers to a ring down of the resonant transducer by at least 25 dB. In accordance with one preferred embodiment of this invention, the second electrical pulse is applied at a time corresponding to about a ½ period of the first waveform and produces a second waveform having an amplitude corresponding to the amount of inherent damping of the first waveform at about the time corresponding to the ½ period, that is, the time at which the second electrical pulse is applied. The second electrical pulse thus applied causes substantial damping of the oscillator and, thus, braking of the first waveform.

The apparatus of this invention comprises waveforming means for producing a first waveform having a first amplitude and a phase and for producing a second waveform having an amplitude corresponding to the amount of inherent damping of the first waveform at about a ½ period of the first waveform and having a phase delay corresponding to about said ½ period. The apparatus further comprises means for detecting at least one reflected waveform reflected by a surface. In accordance with one particularly preferred embodiment of this invention, the waveforming means comprises at least one resonant transducer. In accordance with one preferred embodiment, the resonant transducer is a piezoelectric transducer.

### BRIEF DESCRIPTION OF THE DRAWINGS

These and other objects and features of this invention will be better understood from the following detailed description taken in conjunction with the drawings wherein:

FIGS. 1A and 1B are diagrams showing graphic representations of oscillations of the oscillating element of a resonant transducer after application of first and second electrical pulses, respectively, to the resonant transducer in accordance with one embodiment of this invention, and FIG. 1C is a diagram showing a graphical representation of the resulting oscillation of the oscillating element after application of both the first and second electrical impulses in accordance with one embodiment of this invention;

FIG. 2 is a diagram showing a graphic simulation of a resonant transducer with electronic damping in accordance with one embodiment of this invention;

FIG. 3 is a diagram showing the sensitivity of the method of this invention; and

FIG. 4 is a diagram showing a system for determining the thickness of an object in accordance with one embodiment of the method of this invention.

### DETAILED DESCRIPTION OF THE PRESENTLY PREFERRED EMBODIMENTS

Although described herein in the context of resonant transducers producing acoustic waveforms, the method of this invention is suitable for use in connection with any waveform producing apparatus, and such methods and apparatuses are deemed to be within the scope of this invention. It is also to be understood that, although some of the applications of the method and apparatus of this invention involve the use of gas couplants, this invention is not so limited and may be applied as well to applications employing other types of coupling media such as liquids, soils and the like.

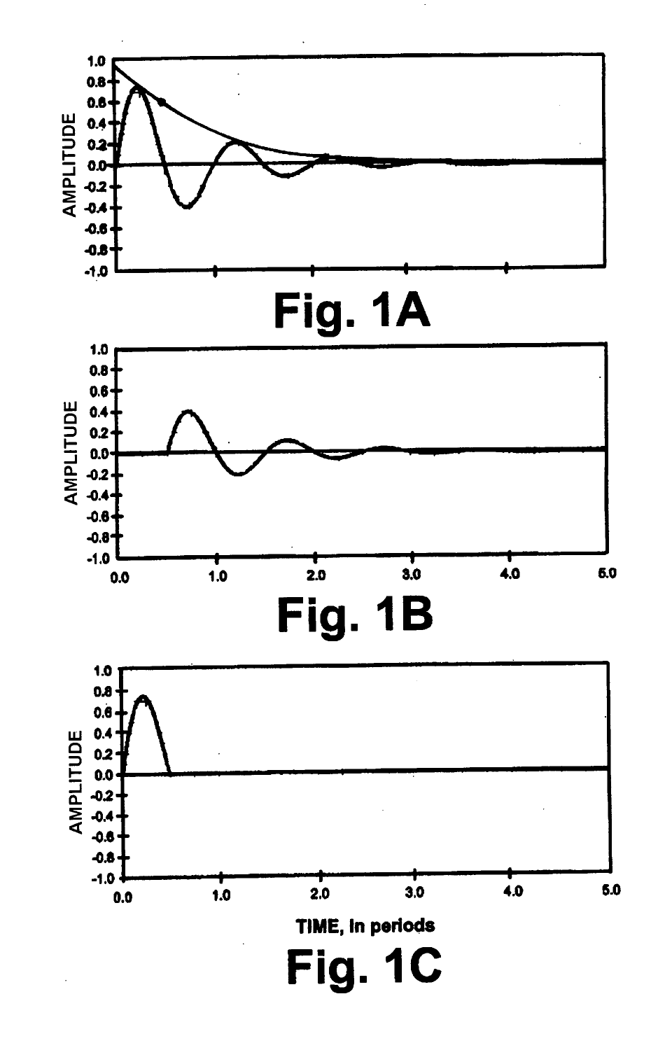

The method in accordance with one embodiment of this invention comprises driving a resonant transducer with an initial electrical pulse of a given polarity, resulting in the generation of a first waveform, followed by driving the resonant transducer with a second electrical pulse having the same polarity as the initial electrical pulse, resulting in the generation of a second waveform, wherein the second waveform has an amplitude and phase delay selected to be coincidental with braking of the motion of the oscillating element of the resonant transducer after occurrence of the second electrical pulse. FIG. 1A shows a waveform representation of oscillation of the oscillating element of a resonant transducer after application of the initial electrical pulse to the resonant transducer. Also shown in FIG. 1A is a curve representative of the inherent damping of the resonant transducer and, thus, the waveform shown therein. The equation used to derive the curve corresponding to the inherent damping of the resonant transducer is as follows:
Y₍ₜ₎=Ae^{-αt} sin 2πfᵣt
where
Y₍ₜ₎=amplitude at any time t
A=initial amplitude
α=damping coefficient
t=time
fᵣ=resonant frequency of the transducer.
   The term Ae^{-αt} corresponds to the inherent damping of the resonant transducer.

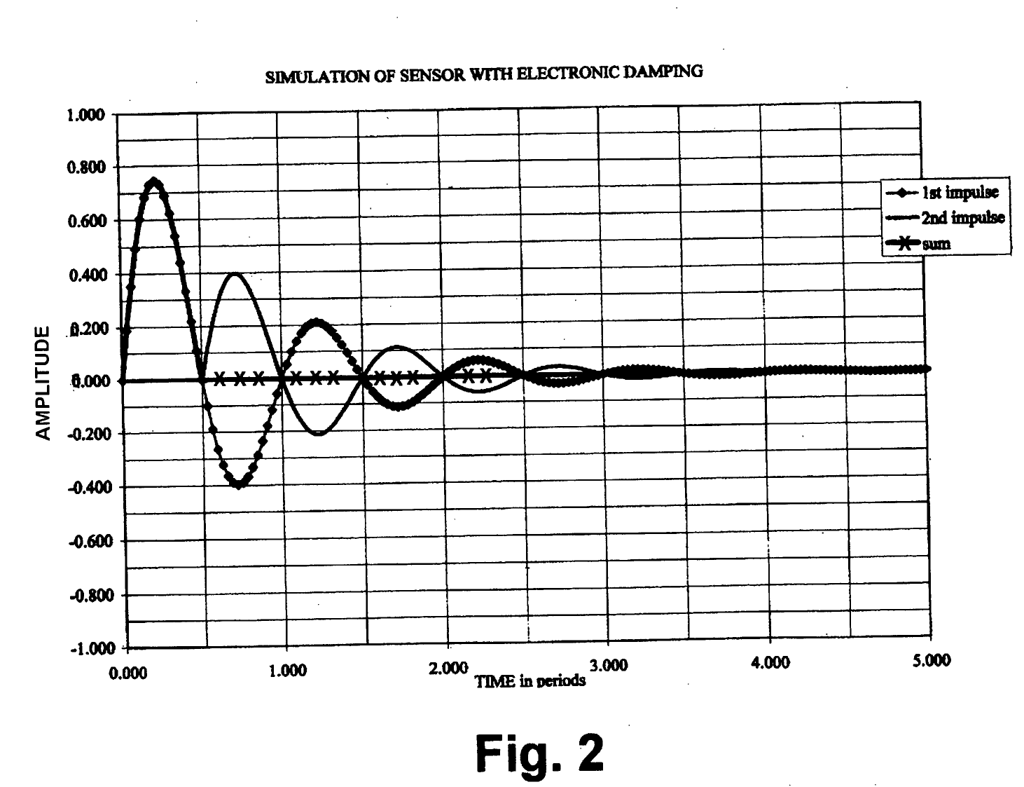

FIG. 1B shows a waveform representation of oscillation of the oscillating element when subjected to an electrical pulse having the characteristics of the second electrical pulse in accordance with one embodiment of the method of this invention. FIG. 1C shows a waveform representation of oscillation of the oscillating element of a resonant transducer after application of both the first and second electrical pulses in accordance with the method of this invention. FIG. 2 shows a waveform representation of the combined waveforms of FIGS. 1A, 1B and 1C. We have calculated that the method of this invention can provide attenuation of more than a factor of 100,000 within the period of the transducer resonant frequency and experimentation has demonstrated the occurrence of some electronic braking of the resonant transducer oscillating element.

The transducers employed in the method of this invention are damped harmonic oscillators that can be characterized by resonant frequency and a damping coefficient. Accordingly, the first step in accordance with one embodiment of this invention is to measure the resonant frequency and damping coefficient of the transducer. This measurement can be made by triggering the resonant transducer with a short electrical pulse, preferably a pulse with a time duration that is short compared to the period (reciprocal of the resonant frequency) of the transducer. In accordance with one preferred embodiment, one half of a period of the resulting waveform, most preferably the first ½ period, constitutes the preferred time delay for the second impulse. The ratio of the amplitude of the second peak to the initial peak can be estimated by calculating the amount of inherent damping of the first waveform at a time equal to the corresponding ½ period. If the transducer's response is pressure dependent, then it may be necessary to perform these measurements as a function of pressure. To obtain a large amount of electronic braking, i.e. damping, the timing and amplitude of the second impulse are critical. For example, to obtain braking by a factor of about 10,000 at the end of the first period requires that the amplitude of the second pulse be adjusted to 1 part in 10,000 or better relative to the first pulse and that the time be adjusted to 1 part in 20,000 or better relative to the first pulse. For a 5 MHz sensor, the timing of the second pulse is preferably within 5 picoseconds.

As previously indicated, one preferred embodiment of the method of this invention comprises the application of an initial electrical pulse followed by a second electrical pulse, where both electrical pulses have the same polarity and the second electrical pulse is generated after a time delay corresponding to about ½ period of the waveform generated by the initial electrical pulse. However, effective damping of the resonant transducer can also be achieved where the second electrical pulse is generated after a time delay corresponding to any half period of the first waveform, that is, for example, after 1½ periods, 2½ periods, 3½ periods, etc. The amplitude of the second waveform would correspond to the inherent damping of the first waveform at the selected ½ period. A result of delaying generation of the second pulse beyond the first ½ period of the first waveform is a delay in damping of the resonant transducer. However, so long as damping of the resonant transducer is achieved before a reflected signal strikes the transducer, the ability to detect reflected signals in the simple manner accorded by the method of this invention is substantially retained. By comparison, if the delay in generating the second electrical pulse is such that damping of the resonant transducer is not achieved before a reflected signal strikes the transducer, then detection of the reflected signal, if at all possible, is much more difficult.

As previously indicated, one of the objects of this invention is to provide a method and apparatus for electronically damping a resonant transducer that provides short pulses that utilize only a single polarity (positive or negative) drive circuit. However, electronic damping of a resonant transducer may also be achieved in accordance with one embodiment of this invention in which the initial electrical pulse and the second electrical pulse have opposite polarities. In this case, the time delay for generation of the second electrical pulse corresponds to whole periods of the first waveform, that is after one period, two periods, three periods, etc. of the first waveform. And, the amplitude of the second waveform preferably corresponds to the inherent damping of the first waveform at the selected whole period. Thus, if the time delay for the second electrical pulse is one period of the first waveform, then the amplitude of the second waveform should correspond to the inherent damping of the first waveform at approximately said one period. It will be apparent to those skilled in the art that, although this embodiment is effective in electronically damping a resonant transducer, the use of both positive and negative polarity electrical pulses requires the use of more complex electrical circuitry compared to the embodiment of this invention in which only a single polarity electrical pulse is employed. In addition, because of the increase in the time delay for generating the second electrical pulse, the ability to detect a reflected signal may be hindered.

Suitable generators for generating the first and second pulses are exclusive OR pulse generators available from Fairchild Semiconductor, South Portland, Me., National Semiconductor, Santa Clara, Calif. and Texas Instruments, Dallas, Tex. Timing between initiation of the first and second impulses can be controlled using a commercial digital delay/pulse generator, e.g. an SRS DG535 generator available from Stanford Research Systems of Sunnyvale, Calif.

By way of example, in gas coupled ultrasonics, a piezoelectric transducer is used to generate an ultrasonic signal, the purpose of which is to measure the wall thickness of metal pipelines. The design specifications for such a transducer include a resonant frequency of 5 MHz and the ability to ring down by 80 dB in 2 microseconds. However, no known transducers are able to meet this specification. Calculations show that it is possible for a resonant transducer with some mechanical damping and ideal electric damping produced in accordance with the method of this invention to ring down by as much as 140 dB in 2 microseconds. It is to be understood that the method of this invention is not frequency limited, although large amounts of electronic damping are easier to achieve at lower frequencies given the limitations of today's electronics.

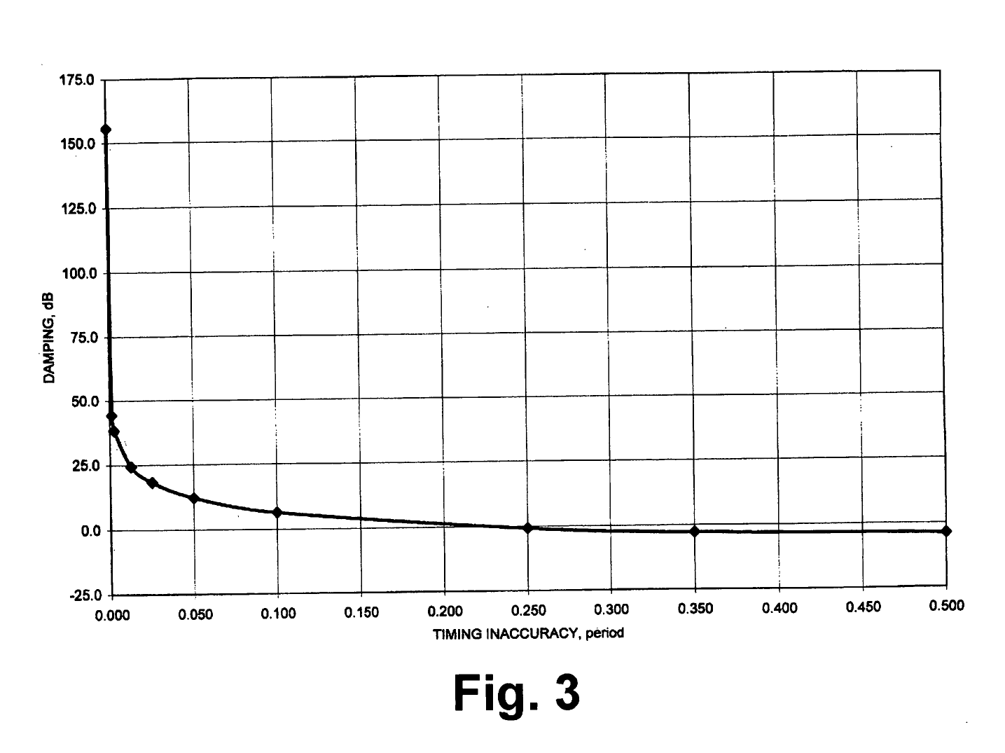

FIG. 3 is a graphical representation showing the sensitivity as well as the unforeseeability of the results of the method of this invention. As previously indicated, to be effective, for example, in gas coupled ultrasonic applications, it is generally required that a resonant transducer having a resonant frequency of 5 MHz be able to ring down by 80 dB in 2 microseconds, a specification which, here to date, no known transducer has been able to meet. As can be seen from FIG. 3, this requirement is easily satisfied by application of the method of this invention. However, as the precision with which the method is implemented is reduced, that is, the further off the specified half period or whole period of the first waveform that the second electrical pulse is applied to the transducer, the lower is the amount of damping achieved. Indeed, if the inaccuracy of the generation of the second electrical pulse is greater than a factor of about 0.0125 off the desired half peak or whole peak, the amount of damping achieved decreases to well below the desired ring down of at least 80 dB.

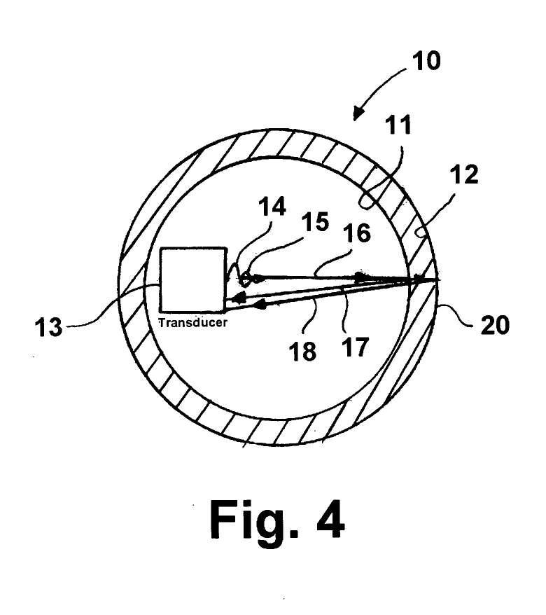

FIG. 4 shows a system for determining the wall thickness of a gas pipeline 10 in accordance with one embodiment of this invention. As shown therein, a transducer 13 is disposed within gas pipeline 10, within which a gaseous fluid, which acts as a couplant, is disposed, and emits a first signal 14 followed by a second signal 15 generated as described herein above, resulting in the formation of a substantially electronically damped signal 16. The electronically damped signal 16 hits the interior surface 11 of the pipeline wall, producing a reflected signal 17, which is detected by transducer 13. A portion of electronically damped signal 16 continues into the wall of pipeline 10 and is reflected back off of the inner boundary 12 defined by the exterior surface 20 of pipeline 10. The reflected signal 18 is also detected by transducer 13. Using computational means known to those skilled in the art, the thickness of the wall of pipeline 10 can be determined based upon the time delay between the detection of the reflected signal 17 off the interior surface 11 of the pipeline and the detection of the reflected signal 18 off the inner boundary 12. Because the resonant transducer is substantially damped in accordance with the method of this invention, interference by the resonant transducer in detecting the reflected signals 17, 18 is virtually eliminated, thereby substantially simplifying determination of the wall thickness. In addition, because the resonant transducer is substantially damped in accordance with the method of this invention, the resulting reflected waveforms 17 and 18 are simpler in shape and shorter in time duration, thereby substantially simplifying the determination of wall thicknesses.

As shown in FIG. 4, resonant transducer 13 is operating in a pulse echo mode. That is, the same transducer generates both the first and second signals as well as detects the reflected signals. However, although slightly more complicated, the method of this invention may be implemented using a pitch-catch pair of resonant transducers, where one of the transducers of the pair of transducers generates the signals and the second transducer detects the reflected signals. Typically, such transducers will be disposed adjacent to one another.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

1. A method for electronically damping an oscillator of a resonant transducer comprising the steps of:
applying a first electrical pulse to said resonant transducer, oscillating said oscillator, thereby forming a first waveform having a first amplitude and a phase; and
applying a second electrical pulse to said resonant transducer, forming a second waveform having a phase delay relative to said phase of said first waveform, resulting in substantial damping of said oscillator.

2. A method in accordance with claim 1, wherein said phase delay corresponds to about a ½ period of said first waveform.

3. A method in accordance with claim 1, wherein said second waveform has an amplitude representative of inherent damping of said first waveform proximate a time corresponding to about a ½ period of said first waveform.

4. A method in accordance with claim 2, wherein said phase delay corresponds to about a first said ½ period of said first waveform.

5. A method in accordance with claim 1, wherein said first electrical pulse and said second electrical pulse have the same polarity.

6. A method in accordance with claim 1, wherein said phase delay corresponds to a whole period of said first waveform.

7. A method for electronically damping resonant transducers comprising the steps of:
generating a first waveform having a first amplitude and a phase using a resonant transducer; and
generating a second waveform using said resonant transducer, said second waveform having both a phase delay relative to said phase of said first waveform and an amplitude coincidental with substantial damping of said resonant transducer.

8. A method in accordance with claim 7, wherein said second waveform is generated at a time corresponding to about a ½ period of said first waveform.

9. A method in accordance with claim 7, wherein said amplitude of said second waveform corresponds to an inherently damped said first amplitude proximate a time corresponding to about a ½ period of said first waveform.

10. A method in accordance with claim 7, wherein said phase delay corresponds to about a ½ period of said first waveform and said amplitude corresponds to an inherently damped said first amplitude at about said ½ period of said first waveform.

11. A method in accordance with claim 7, wherein said resonant transducer is disposed in a gaseous environment.

12. A method for determining a thickness of an object comprising the steps of:
with a resonant transducer, generating and directing a first waveform having a first amplitude and a phase toward said object;
with said transducer, generating and directing a second waveform toward said object, said second waveform having both a phase delay relative to said phase of said first waveform and an amplitude coincidental with substantial damping of said resonant transducer;
detecting a first reflected waveform reflected by said object;
detecting a second reflected waveform reflected by said object;
determining an elapsed time period between detection of said first reflected waveform and detection of said second reflected waveform; and
determining a thickness of said object based upon said elapsed time period.

13. A method in accordance with claim 12, wherein said resonant transducer and a side of said object facing said resonant transducer are disposed in a gaseous environment.

14. A method in accordance with claim 12, wherein said phase delay corresponds to about a ½ period of said first waveform.

15. A method in accordance with claim 12, wherein said amplitude of said second waveform corresponds to an inherently damped said first amplitude proximate a time corresponding to about a ½ period of said first waveform.

16. A method in accordance with claim 12, wherein said object is a wall.

17. A method in accordance with claim 16, wherein said resonant transducer is disposed within a gaseous fluid-containing pipeline.

18. A method in accordance with claim 12, wherein said resonant transducer is used in a pulse echo mode.

19. A method in accordance with claim 12, wherein said resonant transducer is driven using a single polarity drive circuit.

20. An apparatus comprising:
waveforming means for producing a first waveform having a first amplitude and a phase and for producing a second waveform having an amplitude corresponding to an inherently damped said first amplitude at about a ½ period of said first waveform and having a phase delay corresponding to about said ½ period; and
means for detecting at least one reflected waveform reflected by a surface.

21. An apparatus in accordance with claim 20, wherein said waveforming means comprises at least one resonant transducer.

22. An apparatus in accordance with claim 20, wherein said at least one resonant transducer comprises a single polarity drive circuit.

23. An apparatus in accordance with claim 20, wherein said means for detecting said at least one reflected waveform is integral with said at least one resonant transducer.

24. An apparatus in accordance with claim 20 further comprising means for determining an elapsed time between detection of at least two said reflected waveforms.
